(19) United States
(12) Patent Application Publication
(10) Pub. No.: US 2015/0204237 A1
(43) Pub. Date: Jul. 23, 2015

(54) TURBINE BLADE AND METHOD FOR ENHANCING LIFE OF THE TURBINE BLADE

(71) Applicant: General Electric Company, Schenectady, NY (US)

(72) Inventors: William Scott Zemitis, Simpsonville, SC (US); Ariel Caesar Prepena Jacala, Travelers Rest, SC (US); Jason Douglas Herzlinger, Schenectady, NY (US)

(73) Assignee: General Electric Company, Schenectady, NY (US)

(21) Appl. No.: 14/157,581

(22) Filed: Jan. 17, 2014

(51) Int. Cl. F02C 3/04

(52) U.S. Cl. CPC F02C 3/04

(57) ABSTRACT

A turbine blade comprises a cooling passage defined between a pressure side wall and a suction side wall. A pin is disposed within the cooling passage and includes a first end that is connected to the pressure side wall and a second end that is connected to the suction side wall. A radially oriented fillet having a maximum radius of curvature value is disposed along a periphery of at least one of the first end or the second end within a region of peak steady state stress. An axially oriented fillet having a maximum radius of curvature value is disposed along a periphery of at least one of the first end or second end within a region of peak vibratory stress. The maximum radius of curvature value of the axially oriented fillet is greater than the maximum radius of curvature value of the radially oriented fillet.

### FIELD OF THE INVENTION

The present invention generally involves a turbine blade for a gas turbine. More specifically, the invention relates to a turbine blade having a pin arranged in a pin bank array and a method for enhancing mechanical performance of the turbine blade.

### BACKGROUND OF THE INVENTION

A turbine section of a gas turbine generally includes multiple rows or stages of turbine blades that are coupled to a rotor shaft. A first row of stationary vanes may be disposed upstream from a first row of turbine blades at an inlet to the turbine section. Sequential rows of stator vanes are disposed within the turbine section between sequential rows of turbine blades. A casing surrounds the rows of stationary vanes and turbine blades to define a hot gas path through the turbine section. In operation, high temperature combustion gases are routed across the first row of stationary vanes and through the hot gas path defined within the turbine section. Thermal and/or kinetic energy is extracted from the combustion gases via the stationary vanes and the turbine blades, thereby causing the turbine blades to move, thus resulting in rotation of the rotor shaft.

Due to the high temperature-environment within the hot gas path, some of the turbine blades are at least partially hollow so as to define internal cooling channels therein. A cooling medium such as compressed air or steam may be routed through the cooling channels, thereby improving thermal performance of the turbine blades. In particular turbine blade designs, a plurality of pins or pin fins extend within the cooling passage between a pressure side and a suction side of the turbine blade generally proximate to a trailing edge portion of the turbine blade. The pins improve heat transfer efficiency and may provide structural support to the turbine blade.

Various factors such as rotational forces, non-uniform thermal growth between the suction side and the pressure side and vibrational forces resulting from pressure oscillations of the combustion gases flowing from a preceding row of stationary vanes results in peak steady state stresses and peak vibratory stresses on the turbine blades at the connection points between the first and second ends of the pins and the pressure and suction side walls. Conventional pin designs provide uniform stiffness for both static and vibratory conditions which may not be optimal for either. Therefore, improvements to the pins and a method to enhance overall mechanical performance of the turbine blades would be useful.

### BRIEF DESCRIPTION OF THE INVENTION

Aspects and advantages of the invention are set forth below in the following description, or may be obvious from the description, or may be learned through practice of the invention.

One embodiment of the present invention is a turbine blade. The turbine blade includes a leading edge, a trailing edge, a pressure side wall and a suction side wall. The pressure side wall and the suction side wall extend between the leading and trailing edges. A cooling passage is defined between the pressure and suction side walls. A pin is disposed within the cooling passage. The pin includes a first end that is connected to the pressure side wall and a second end that is connected to the suction side wall. A radially oriented fillet is disposed along a periphery of at least one of the first end or the second end within a region of peak steady state stress. The radially oriented fillet has a maximum radius of curvature value. An axially oriented fillet is disposed along a periphery of at least one of the first end or second end within a region of peak vibratory stress. The axially oriented fillet has a maximum radius of curvature value that is greater than the maximum radius of curvature value of the radially oriented fillet.

Another embodiment of the present invention is a gas turbine. The gas turbine includes a compressor, a combustor disposed downstream from the compressor, and a turbine having a plurality of rotatable turbine blades. At least one of the turbine blades comprises an airfoil having a leading edge, a trailing edge, a pressure side wall and a suction side wall that extend radially between a root portion and a tip portion and between the leading and trailing edges. A cooling passage is defined between the pressure and suction side walls proximate to the trialing edge. The turbine blade includes a pin that is disposed within the cooling passage. The pin includes a first end that is connected to the pressure side wall and a second end that is connected to the suction side wall. A radially oriented fillet is disposed along a periphery of at least one of the first end or the second end within a region of peak steady state stress. The radially oriented fillet has a maximum radius of curvature value. An axially oriented fillet is disposed along a periphery of at least one of the first end or second end within a region of peak vibratory stress. The axially oriented fillet has a maximum radius of curvature value that is greater than the maximum radius of curvature value of the radially oriented fillet.

The present invention also includes a method for enhancing mechanical durability of a turbine blade having a pressure side wall, a suction side wall, a cooling passage defined therebetween and at least one pin disposed within the cooling passage. The pin includes a first end connected to the pressure side wall and a second end connected to the suction side wall. The method includes identifying at least one region of peak steady state stress along the periphery of at least one of the first end and the second end of the pin, defining a radially oriented fillet along the corresponding periphery proximate to the region of peak steady state stress where the radially oriented fillet having a point along the corresponding periphery that defines a maximum radius of curvature value. The method further includes identifying at least one region of peak vibratory stress along the periphery of at least one of the first end and the second end of the pin. The method also includes defining an axially oriented fillet along the corresponding periphery proximate to the region of peak vibratory stress where the axially oriented fillet includes a point that defines a maximum radius of curvature value where the maximum radius of curvature value for the axially oriented fillet is greater than the maximum radius of curvature value for the radially oriented fillet.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set fourth more particularly in the remainder of the specification, including reference to the accompanying figures, in which:

FIG. 1 is an example of an exemplary gas turbine as may incorporate various embodiments of the present invention;

FIG. 2 is a perspective view of an exemplary turbine blade as may incorporate various embodiments of the present invention;

FIG. 3 is a cross sectional top view of the turbine blade taken at line 3-3 as shown in FIG. 2, according to one embodiment of the present invention;

FIG. 4 is a cross sectional side view of the turbine blade taken along line 4-4 as shown in FIG. 2, according to one embodiment of the present invention;

FIG. 5 is an enlarged top view of a portion of the turbine blade as shown in FIG. 3, including an exemplary pin disposed within a cooling passage according to one embodiment of the present invention;

FIG. 6 is an enlarged front view of a portion of the turbine blade as shown in FIG. 2, including the exemplary pin as shown in FIG. 5, disposed within the cooling passage, according to one embodiment of the present disclosure;

FIG. 7 is a cross sectional side view of one end of the pin as shown in FIGS. 5 and 6, according to one embodiment of the present invention;

FIG. 8 is an enlarged cross sectional side view of a first end of the pin as shown in FIGS. 5 and 6, according to at least one embodiment of the present invention;

FIG. 9 is an enlarged cross sectional front view of a portion of a turbine blade including a pin as shown in FIG. 8, according to at least one embodiment of the present invention;

FIG. 10 is an enlarged cross sectional side view of a second end of the pin as shown in FIG. 9, according to at least one embodiment of the present invention;

FIG. 11 is an enlarged cross sectional top view of a portion of the turbine blade as shown in FIG. 2, according to at least one embodiment of the present invention;

FIG. 12 is an enlarged cross sectional side view of an exemplary pin that is representative of either of the first or second ends of the exemplary pin, according to at least one embodiment of the present invention;

FIG. 13 is an enlarged cross sectional top view of a portion of a turbine blade including the pin as illustrated in FIG. 12, according to at least one embodiment of the present invention; and

FIG. 14 is a block diagram of a method for enhancing durability of a turbine blade, according to at least one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel or coaxially aligned with an axial centerline of a particular component.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although exemplary embodiments of the present invention will be described generally in the context of an industrial or land based gas turbine for purposes of illustration, one of ordinary skill in the art will readily appreciate that embodiments of the present invention may be applied to any turbomachine such as an aircraft gas turbine or a marine gas turbine and is not limited to an industrial or land based gas turbine unless specifically recited in the claims.

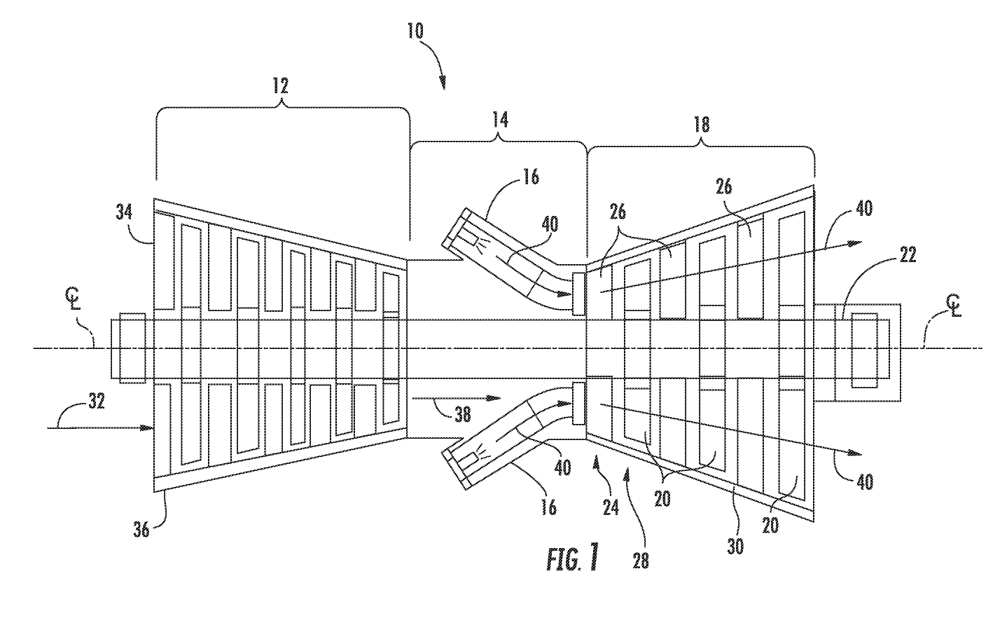

Referring now to the drawings, wherein like numerals refer to like components, FIG. 1 illustrates an example of a gas turbine 10 as may incorporate various embodiments of the present invention. As shown, the gas turbine 10 includes a compressor section 12, a combustion section 14 having one or more combustors 16 that are disposed downstream form the compressor section 12, and a turbine section 18 disposed downstream from the combustion section 14. The turbine section 18 generally includes multiple rows or stages of turbine blades 20 that are coupled to a rotor shaft 22. A first row 24 of stationary vanes 26 may be disposed upstream from a first row 28 of the turbine blades 20 at an inlet of the turbine section 18. Sequential rows of stationary vanes 26 are disposed within the turbine section 18 between sequential rows of turbine blades 20. A casing 30 surrounds the rows of stationary vanes and turbine blades to at least partially define a hot gas path through the turbine section 18.

In operation, a working fluid 32 such as air enters an inlet 34 of a compressor 36 of the compressor section 12. The working fluid 32 is progressively compressed as it flows through the compressor 36 towards the combustion section 14 to provide a compressed working fluid 38 to the combustion section 14. Fuel is mixed with the compressed working fluid 38 within each combustor 16 and the mixture is burned to produce combustion gases 40 at a high temperature and a high velocity. The combustion gases 40 are routed from each combustor 16 across the first row 24 of stationary vanes 26 and through the hot gas path defined within the turbine section 18. Thermal and/or kinetic energy is extracted from the combustion gases 40 via the stationary vanes 26 and the turbine blades 20, thereby causing the turbine blades to rotate, thus resulting in rotation of the rotor shaft 22.

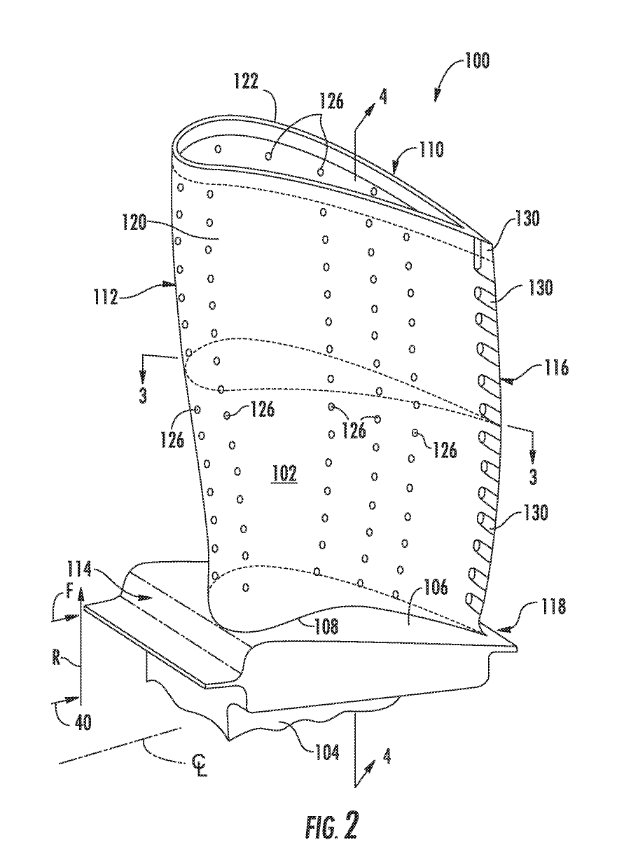

FIG. 2 is a perspective view of an exemplary turbine blade 100 as may incorporate various embodiments of the present invention and as may be incorporated into the turbine section 18 in place of turbine blade 20 as shown in FIG. 1. As shown in FIG. 2, the turbine blade 100 generally includes an airfoil or blade 102 that extends radially outwardly from a base 104 of the turbine blade 100. The base 104 may be adapted to connect the turbine blade 100 to the rotor shaft 22 (FIG. 1). For example, the base 104 may have a profile such as a dovetail or groove shape (not shown) that is suited to engage with a complementary slot (not shown) defined within a rotor disk (not shown) that is attached to the rotor shaft 22.

In particular embodiments, as shown in FIG. 2, the airfoil 102 extends radially outwardly from a platform portion 106 of the base 104. A root portion 108 of the airfoil 102 is defined where the airfoil 102 and the platform portion 106 intersect. A radial end or tip portion 110 of the airfoil 102 is distal to the root portion 108. The airfoil 102 includes a leading edge 112 that extends between the root portion 108 and the tip portion 110 proximate to a forward or upstream portion 114 of the turbine blade 100. The leading edge 112 generally faces into a direction of flow F of the combustion gases 40. A trailing edge 116 extends between the root portion 108 and the tip portion 110 proximate to an aft or downstream portion 118 of the turbine blade 100. A pressure side wall 120 extends radially between the root portion 108 and the tip portion 110 and between the leading edge 112 and the trailing edge 116. A suction side wall 122 is spaced apart from the pressure side wall 120. The suction side wall 122 extends radially between the root portion 108 and the tip portion 110 and between the leading edge 112 and the trailing edge 116.

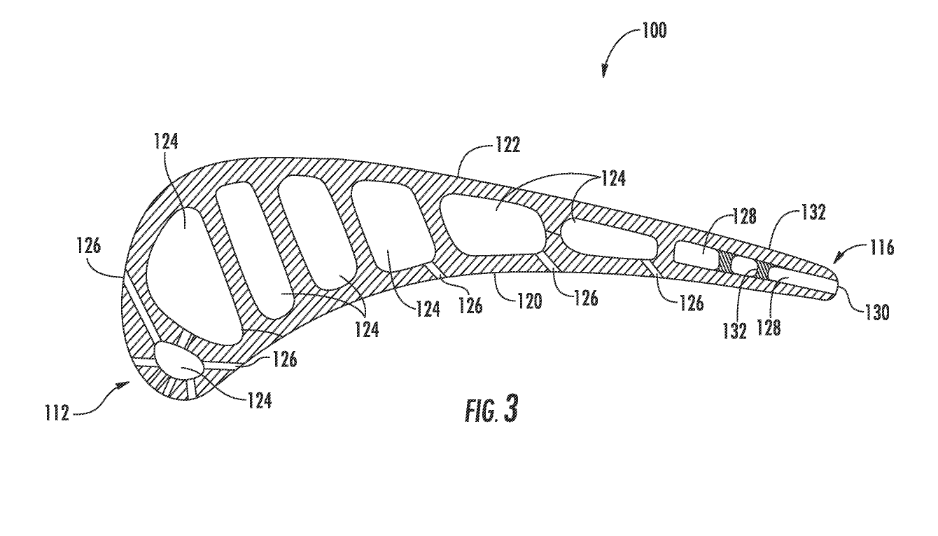

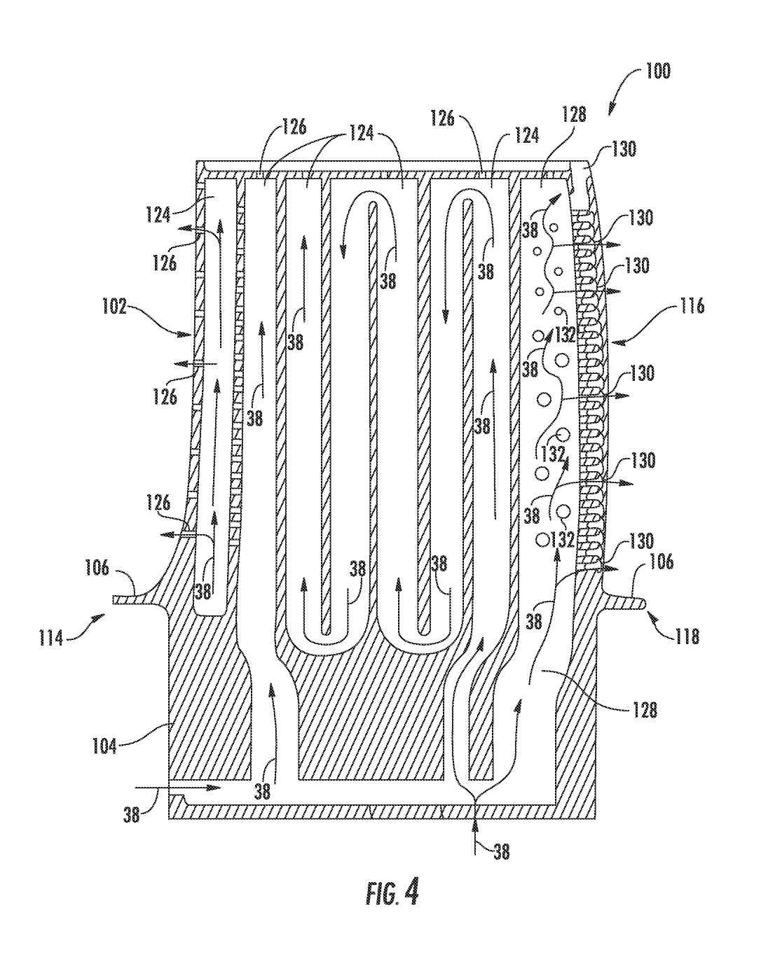

FIG. 3 provides a cross sectional top view of the turbine blade 100 taken at line 3-3 as shown in FIG. 2, according to one embodiment of the present invention. FIG. 4 provides a cross sectional side view of the turbine blade taken along line 4-4 as shown in FIG. 2, according to one embodiment. In particular embodiments, as shown in FIGS. 3 and 4, at least one cooling passage 124 extends at least partially through the airfoil 102. As shown in FIG. 3, the cooling passage(s) 124 are at least partially defined between the pressure side wall 120 and the suction side wall 122.

In operation, as shown in FIG. 4, a cooling medium such as a portion of the compressed working fluid 38 is routed through the cooling passages 124 to provide conductive and/or convective cooling to the airfoil 102. In particular embodiments, a plurality of cooling holes 126 provide for fluid communication from the cooling passage(s) 124 through the airfoil 102. For example, as shown in FIGS. 2, 3 and 4, cooling holes 126 may be disposed at each or any one of the leading edge 112, the pressure side wall 120, the trailing edge 116 or at the tip portion 110 (FIGS. 2 and 4). In this manner, the cooling medium may be routed through the cooling holes 126 to provide film cooling to an outer surface of the airfoil 102, thus enhancing overall durability of the turbine blade 100.

In one embodiment, as shown in FIGS. 3 and 4, a cooling passage 128 is defined between the pressure side wall 120 and the suction side wall 122 proximate to the trialing edge 116. One or more cooling holes 130 provide for fluid communication out of the cooling passage 128, thus providing for localized cooling of the airfoil 102 proximate to the trailing edge 116. One or more pins 132 or pin fins are disposed within the cooling passage 128. The pins 132 may form a pin bank or array which provides enhanced cooling of the airfoil 102 through the cooling passage 128 as is well known in the art.

FIG. 5 is an enlarged top view of a portion of the turbine blade 100 as shown in FIG. 3 including an exemplary pin 132 disposed within the cooling passage 128 according to one embodiment of the present disclosure. FIG. 6 is an enlarged front view of a portion of the turbine blade 100 taken along lines 6-6 as shown in FIG. 2 including the exemplary pin 132 (FIG. 5) disposed within the cooling passage 128, according to one embodiment of the present disclosure.

As shown in FIGS. 5 and 6, the pin 132 includes a main body 134 that extends between the pressure side wall 120 and the suction side wall 122. The main body 134 includes a first end 136 that is connected to the pressure side wall 120 and a second end 138 that is connected to the suction side wall 122. The pin 132 may be formed in situ by casting, machining, or 3D printing or by any other method known in the art for forming a pin within an airfoil. In the alternative, the pin 132 may be welded, brazed or otherwise mechanically fixed to the pressure side wall 120 and the suction side wall 122.

In operation, the turbine blade 100 is exposed to both steady state stresses and vibratory stresses. Primarily, the steady state stresses are generally the result of shear forces due to non-uniform thermal growth in the radial direction between the pressure side wall 120 and the suction side wall 122 and/or centrifugal forces resulting from the rotation of the turbine blades 100. In either case, the shear forces result in steady state stresses in the radial direction at the first and second ends 136, 138 of the pin 132 which may limit the durability or mechanical performance of the turbine blade 100. The steady state stresses are generally associated with low cycle fatigue of the turbine blade 100.

FIG. 7 is a cross sectional side view of one end of the pin 132 as shown in FIGS. 5 and 6. It is intended that FIG. 7 may be representative of both of the first and second ends 136, 138 of the pin 132. As illustrated in FIG. 7, regions of peak or maximum steady state stress 140 generally occur along a periphery of the pin 132 proximate to a radially inner portion 142 of the pin 132 and/or along the periphery at a radially outer portion 144 of the pin 132 at the first and second ends 136, 138. As shown, the radially inner portion 142 of the pin 132 is oriented towards the root portion 108 of the airfoil 102 and the radially outer portion 144 of the pin 132 is oriented towards the tip portion 110 of the airfoil 102.

Vibratory stresses are generally the result of flow induced vibrations caused by non-uniform or unsteady aerodynamic loading on the turbine blade 100 and are typically inertia driven. For example, unsteady aerodynamic loading may result from changes in velocity and/or pressure of the combustion gases 40 flowing towards a rotating turbine blade 100 from an upstream row of stationary vanes 26 thus resulting in low amplitude vibratory loading of the airfoil 102. The flow inducted vibrations are generally associated with high cycle fatigue of the turbine blade 100. Vibratory stresses can be oriented in any direction. However, peak vibratory stresses are most typically not oriented in the radial direction but instead tend to have a larger axial component. In other words, the peak vibratory stresses tend to occur at a point or points along a periphery of the pin 132 between a 6 o'clock and 12 o'clock position.

As illustrated in FIG. 7, regions of peak or maximum vibratory stress 146 generally occur along a periphery of the pin 132 that is proximate to or in the direction of a forward portion 148 of the pin 132 and/or along the periphery at an aft portion 150 of the pin 132 at the first and second ends 136, 138. As shown, the forward portion 148 of the pin 132 is oriented towards the leading edge 112 of the airfoil 102 and the aft portion 150 of the pin 132 is generally oriented towards the trailing edge 116 of the airfoil 102. In many instances, as illustrated in FIG. 7, the regions of peak or maximum steady state stress 140 and the regions of peak or maximum vibratory stress 146 are misaligned along the periphery of the pin at the first and second ends 136, 138. For example, in particular instances, the orientation of the regions of peak or maximum steady state stress 140 and the areas of peak or maximum vibratory stress 146 may be located substantially perpendicular or orthogonal to each other.

Conventional methods for designing turbine blades include using a pin 132 having a constant or uniform diameter and adding a single fillet 152 having a uniform radius around the periphery of the pin 132 at the first and/or second ends 136, 138 to address the peak or maximum vibratory stress 146. In other methods, a single fillet having a non-uniform radius is formed around the periphery at the first and/or second ends 136, 138 of the pin 132 having a constant or uniform diameter to specifically address the peak or maximum vibratory stress 146. These methods utilize relatively large fillets which distribute load across a broader region. Unlike the steady state stress condition where the loading is driven by the stiffness of the pin, the vibratory load is essentially constant. Thus, with the conventional design methods, the primary concern when sizing the pin diameter and the fillet 152 is to distribute the load broadly while maintaining the mechanical integrity of the connection so as to reduce the peak or maximum vibratory stress 146, thus optimizing high cycle fatigue design. As a result, the fillet 152 may not provide ideal flexibility around the periphery of the pin 132 at the first and/or second ends 136, 138 for optimization of the peak or maximum steady state stress 140. Therefore, low cycle fatigue may not be optimized, thus potentially affecting the life of the turbine blade 100.

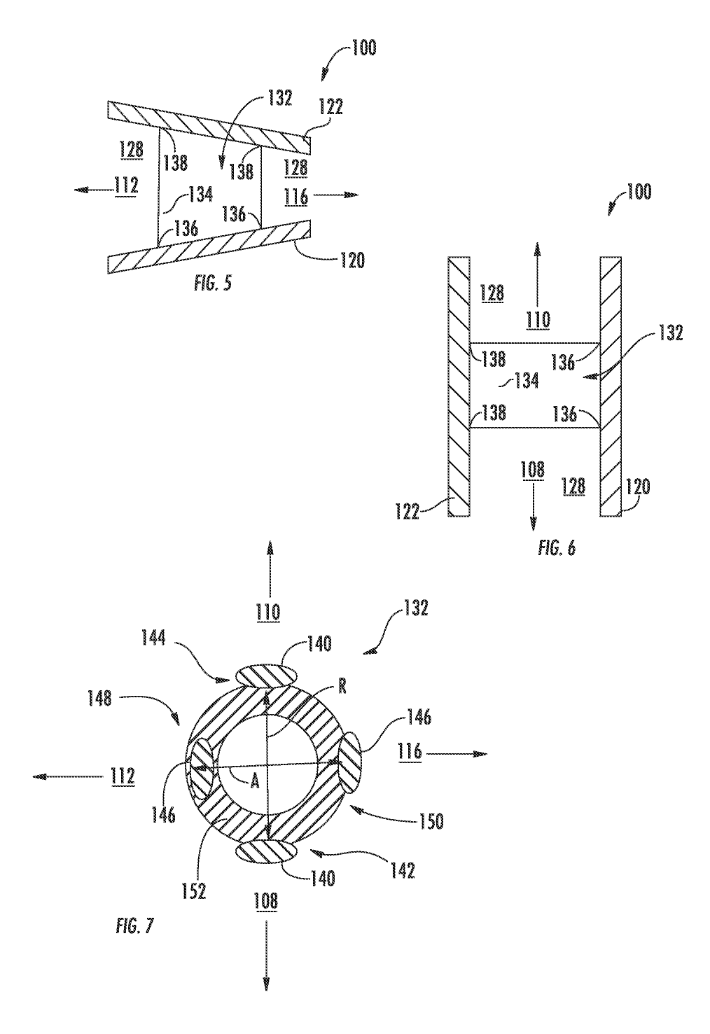

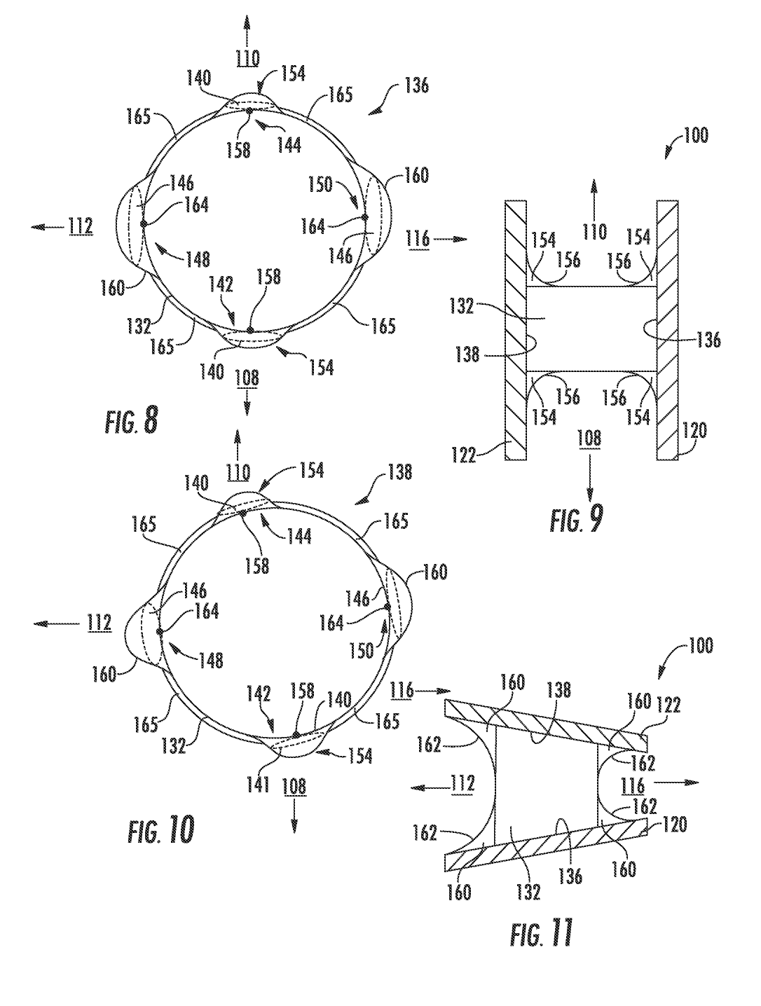

FIG. 8 is an enlarged cross sectional side view of the first end 136 of the pin 132 according to various embodiments of the present invention. FIG. 9 is an enlarged cross sectional front view of a portion of the turbine blade 100 including the pin 132 as shown in FIG. 8, according to various embodiments of the present invention. FIG. 10 is an enlarged cross sectional side view of the second end 138 of the pin 132 according to various embodiments of the present invention. In one embodiment, as illustrated in FIG. 8, areas or regions of peak or maximum steady state stress 140 are identified along the periphery of the first end 136 of the pin 132 proximate to the radially inner portion 142 and/or the radially outer portion 144 of the pin.

In addition or in the alternative, as illustrated in FIG. 10, regions of peak or maximum steady state stress 140 are identified along the periphery of the second end 138 of the pin 132 proximate to the radially inner portion 142 and the radially outer portion 144 of the pin 132. In particular embodiments, as illustrated in FIGS. 8, 9 and 10, at least one radially oriented fillet 154 is disposed along the periphery of the first end 136 (FIGS. 8 and 9) and/or the second end 138 (FIGS. 9 and 10) with each radially oriented fillet 154 being disposed proximate to a separate particular region of peak or maximum steady state stress 140.

In one embodiment, as illustrated in FIGS. 8 and 9, the radially oriented fillet 154 extends or is oriented towards the tip portion 110 of the turbine blade 100 from the first end 136. In one embodiment, the radially oriented fillet 154 extends or is oriented towards the root portion 108 of the turbine blade 100 from the first end 136. In one embodiment, as illustrated in FIGS. 9 and 10, the radially oriented fillet 154 extends or is oriented towards the tip portion 110 of the turbine blade 100 from the second end 138. In one embodiment, the radially oriented fillet 154 extends or is oriented towards the root portion 108 of the turbine blade 100 from the second end 138.

In one embodiment, as illustrated in FIGS. 8 and 9, a pair of radially oriented fillets 154 is disposed along the periphery of the first end 136 such that each radially oriented fillet 154 is proximate to an opposing region of peak or maximum steady state stress 140. For example, one radially oriented fillet 154 extends or is oriented towards the tip portion 110 and the other radially oriented fillet 154 extends or is oriented towards the root portion 108.

In one embodiment, as illustrated in FIGS. 9 and 10, a pair of the radially oriented fillets 154 is disposed along the periphery of the second end 138 such that each radially oriented fillet 154 is proximate to an opposing region of peak or maximum steady state stress 140. For example, one radially oriented fillet 154 extends or is oriented towards the tip portion 110 and the other radially oriented fillet 154 extends or is oriented towards the root portion 108.

FIG. 9 illustrates profiles 156 of four distinct radially oriented fillets 154 in a direction that is substantially perpendicular to the pressure side wall 120 at two locations around the periphery of the first end 136 of the pin 132 and substantially perpendicular to the suction side wall 122 at two locations around the periphery of the second end 138 of the pin 132. In one embodiment, the profile 156 of each radially oriented fillet 154 is generally concave. The profile 156 of each of the radially oriented fillets 154 may be described by a simple curve having a single radius of curvature value at any point along the periphery of the corresponding first end 136 or the second end 138 within the corresponding region of peak or maximum steady state stress 140. It is intended that other profiles of the radially oriented fillet 154 may be encompassed by the present invention, including but not limited to compound curves and elliptical curves.

In one embodiment, as illustrated in FIG. 8, a point 158 is defined along the periphery of the first end 136 and/or the periphery of the second end 138 within each region or peak or maximum steady state stress 140 where a radially oriented fillet 154 occurs. The point 158 corresponds to a local maximum radius of curvature value of the corresponding radially oriented fillet 154. For example, the maximum radius of curvature value defined at point 158 is greater than radii of all other points that are adjacent to point 158 along the periphery of the corresponding first or second ends 136, 138 within the corresponding region of peak or maximum steady state stress 140.

In one embodiment, as illustrated in FIG. 8, point 158 is oriented substantially towards or in the direction of the tip portion 110 of the turbine blade 100 at the first end 136 to specifically address the peak or maximum steady state stress in that particular region of peak or maximum steady state stress 140 and to improve or reduce low cycle fatigue at the first end 136 of the pin 132. In one embodiment, as illustrated in FIG. 8, point 158 is oriented substantially towards or in the direction of the root portion 108 of the turbine blade 100 to specifically address the peak or maximum steady state stress in that particular region of peak or maximum steady state stress 140 and to improve or reduce low cycle fatigue at the first end 136 of the pin 132.

In one embodiment, as illustrated in FIG. 10, point 158 is oriented substantially towards or in the direction of the tip portion 110 of the turbine blade 100 at the second end 138 to specifically address the peak or maximum steady state stress in that particular region of peak or maximum steady state stress, thus improving or reducing low cycle fatigue at the second end 138 of the pin 132. In one embodiment, as illustrated in FIG. 10, point 158 is oriented substantially towards or in the direction of the root portion 108 of the turbine blade 100 at the second end 138 to specifically address the peak or maximum steady state stress in that particular region of peak or maximum steady state stress 140, thus improving or reducing low cycle fatigue at the second end 138 of the pin 132.

In one embodiment, the one or more radially oriented fillets 154 are sized and/or shaped to reduce shear forces within the particular or corresponding regions of peak or maximum steady state stress 140 by providing optimized flexibility while simultaneously providing structural integrity at the corresponding connection between the pressure side wall 120 and the radially outer portion 144 and/or the radially inner portion 142 of the first end 136 of the pin 132, and/or at the corresponding connection between the suction side wall 122 and the radially outer portion 144 and/or the radially inner portion 142 of the second end 138 of the pin 132.

FIG. 11 is an enlarged cross sectional top view of a portion of the turbine blade 100 as shown in FIG. 2, according to various embodiments of the present invention. In one embodiment, as illustrated in FIG. 8, areas or regions of peak or maximum vibratory stress 146 are identified along the periphery of the first end 136 of the pin 132 proximate to the forward portion 148 and/or the aft portion 150 of the pin 132.

In addition or in the alternative, as illustrated in FIG. 10, regions of peak or maximum vibratory stress 146 are identified along the periphery of the second end 138 of the pin 132 proximate to the forward portion 148 and/or the aft portion 150 of the pin 132. In particular embodiments, as illustrated in FIGS. 8, 10 and 11, at least one axially oriented fillet 160 is disposed along the periphery of the first end 136 (FIGS. 8 and 11) and/or the second end 138 (FIGS. 10 and 11) with each axially oriented fillet 160 being disposed proximate to a separate particular region of peak or maximum vibratory stress 146.

In one embodiment, as illustrated in FIGS. 8 and 11, the axially oriented fillet 160 extends or is oriented towards the leading edge 112 of the turbine blade 100 from the first end 136. In one embodiment, the axially oriented fillet 160 extends or is oriented towards the trailing edge 116 of the turbine blade 100 from the first end 136. In one embodiment, as illustrated in FIGS. 10 and 11, the axially oriented fillet 160 extends or is oriented towards the leading edge 112 of the turbine blade 100 from the second end 138. In one embodiment, the axially oriented fillet 160 extends or is oriented towards the trailing edge 116 of the turbine blade 100 from the second end 138.

In one embodiment, as illustrated in FIGS. 8 and 11, a pair of axially oriented fillets 160 is disposed along the periphery of the first end 136 such that each axially oriented fillet 160 is proximate to an opposing region of peak or maximum vibratory stress 146. For example, one axially oriented fillet 160 extends or is oriented towards the leading edge 112 and the other axially oriented fillet 160 extends or is oriented towards the trailing edge 116.

In one embodiment, as illustrated in FIGS. 10 and 11, a pair of the axially oriented fillets 160 is disposed along the periphery of the second end 138 such that each axially oriented fillet 160 is proximate to an opposing region of peak or maximum vibratory stress 146. For example, one axially oriented fillet 160 extends or is oriented towards the leading edge 112 and the other axially oriented fillet 160 extends or is oriented towards the trialing edge 116.

FIG. 11 illustrates profiles 162 of four distinct axially oriented fillets 160 in a direction that is substantially perpendicular to the pressure side wall 120 at two locations around the periphery of the first end 136 of the pin 132 and substantially perpendicular to the suction side wall 122 at two locations around the periphery of the second end 138 of the pin 132. In one embodiment, the profile 162 of each axially oriented fillet 160 is generally concave. The profile 162 of each of the axially oriented fillets 160 may be described by a simple curve having a single radius of curvature value at any point along the periphery of the corresponding first end 136 and/or the second end 138 within the corresponding region of peak or maximum vibratory stress 146. It is intended that other profiles of the axially oriented fillet 160 may be encompassed by the present invention, including but not limited to compound curves and elliptical curves.

In one embodiment, as illustrated in FIG. 8, a point 164 is defined along the periphery of the first end 136 and/or the periphery of the second end 138 within each region of peak or maximum vibratory stress 146 where an axially oriented fillet 160 occurs. The point 164 corresponds to a local maximum radius of curvature value of the corresponding axially oriented fillet 160. For example, the maximum radius of curvature value defined at point 164 is greater than radii of all other points that are adjacent to point 164 along the periphery of the corresponding first or second ends 136, 138 within the corresponding region of peak or maximum vibratory stress 146.

In one embodiment, as illustrated in FIG. 8, point 164 is oriented substantially towards or in the direction of the leading edge 112 of the turbine blade 100 at the first end 136 to address the peak or maximum vibratory stress in that particular region of peak or maximum vibratory stress 146. In one embodiment, as illustrated in FIG. 8, point 164 is oriented substantially towards or in the direction of the trailing edge 116 of the turbine blade 100 at the first end 136 to address the peak or maximum vibratory stress in that particular region of peak or maximum vibratory stress 146.

In one embodiment, as illustrated in FIG. 10, point 164 is oriented substantially towards or in the direction of the leading edge 112 of the turbine blade 100 at the second end 138 to address the peak or maximum vibratory stress in that particular region of peak or maximum vibratory stress 146. In one embodiment, as illustrated in FIG. 10, point 164 is oriented substantially towards or in the direction of the trailing edge 116 of the turbine blade 100 at the second end 138 to address the peak or maximum vibratory stress in that particular region of peak or maximum vibratory stress 146.

The axially oriented fillet or fillets 160 are sized to reduce/remove flexibility or stiffen the connection between the pressure side wall 120 and the forward portion 148 of the first end 136 and/or the second end 138 of the pin 132, thereby reducing or optimizing high cycle fatigue thus enhancing or improving turbine blade life. For example, in particular embodiments, the maximum radius of curvature value defined at point 164 within the region of peak or maximum vibratory stress 146 is greater than the maximum radius of curvature value defined at point 162 within the region or regions of maximum or peak steady state stress 140.

In various embodiments, as shown in FIGS. 8 and 10, a transitional blend or fillet 165 extends between the radially oriented fillet 154 and the axially oriented fillet 160. The profile of the transitional blend or fillet 165 may be described by a simple curve having a single radius of curvature value at any point along the periphery of the corresponding first end 136 or the second end 138 within the corresponding region of peak or maximum steady state stress 140. It is intended that other profiles of the transitional blend or fillet 165 may be encompassed by the present invention, including but not limited to compound curves and elliptical curves.

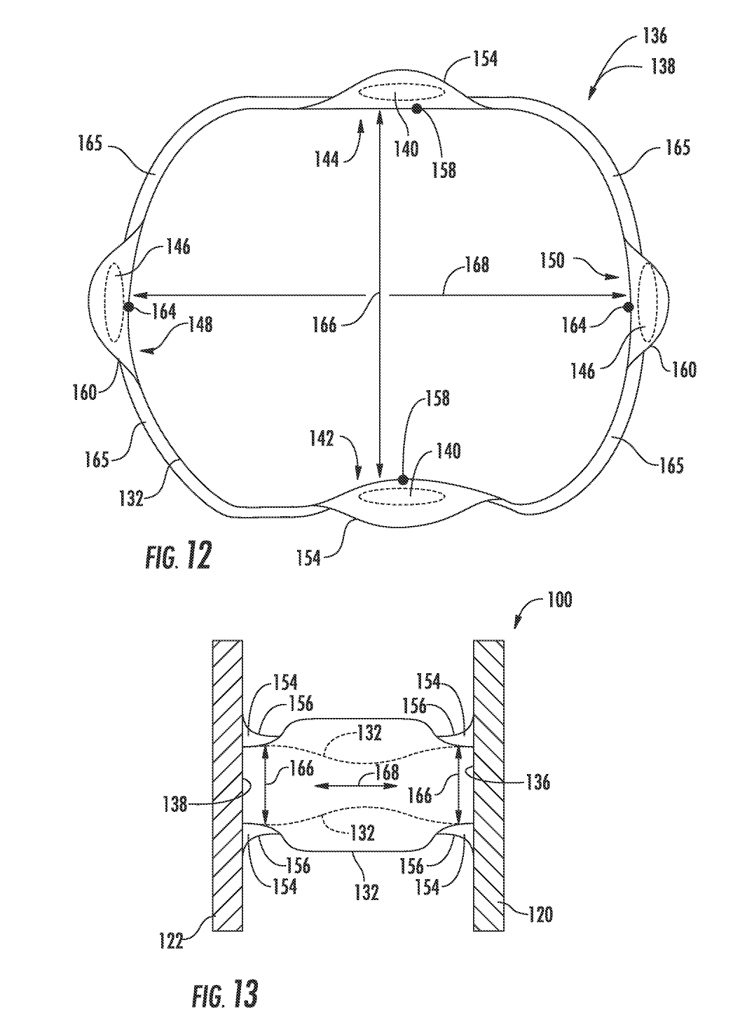

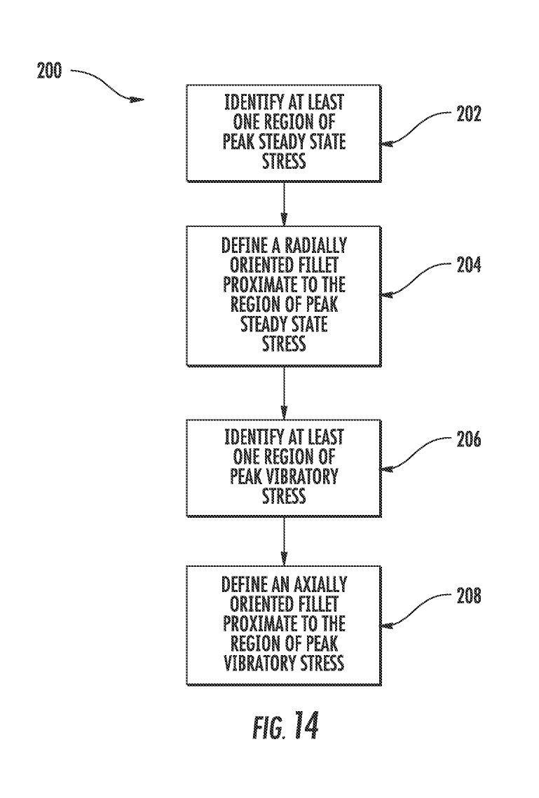

FIG. 12 is an enlarged cross sectional side view that is representative of either of the first or second ends 136, 138 of the pin 132 according to one embodiment of the present invention. FIG. 13 is an enlarged cross sectional top view of a portion of the turbine blade 100 including the pin 132 as illustrated in FIG. 12 according to one embodiment. As illustrated in FIGS. 12 and 13, the pin 132 may have a non-round or non-cylindrical shape or profile in the regions of peak or maximum steady state stress 140. In particular embodiments, the cross sectional radial width is less than a cross sectional axial width 168 of the pin 132. As a result, the non-round or non-cylindrical shape may serve in concert with the radially oriented fillets 154 to reduce or improve low cycle fatigue by reducing a cross sectional radial width 166 of the pin 132 at either or both of the first and second ends 136, 138, thus softening or reducing stiffness within the regions of peak or maximum steady state stress 140.

By exploiting the misalignment of the regions of peak or maximum steady state stress 140 with respect the regions of peak or maximum vibratory stress 146, the size, shape or profile of the radially oriented and the axially oriented fillets 154, 160 and/or the shape of the pin 132 may be optimized to simultaneously provide sufficient stiffness to reduce and/or improve high cycle fatigue resulting from the peak or maximum vibratory stresses 146 while allowing for optimized flexibility and structural integrity to reduce and/or improve low cycle fatigue. As a result, overall turbine blade life/mechanical performance is improved as compared to a single radius fillet.

The various embodiments as describe herein and as illustrated in FIGS. 8-13 provide for a method 200 for enhancing durability of a turbine blade 100 whereby both high cycle fatigue life and low cycle fatigue life are concurrently optimized by exploiting the misalignment between the orientation of the areas of peak or maximum steady state stress 140 and the areas of peak or maximum vibratory stress 146 to enhance and/or improve overall durability or mechanical performance of the turbine blade 100. FIG. 14 provides a block diagram of the method 200 according to one embodiment of the present invention.

At step 202, as shown in FIG. 14, the method 200 includes identifying at least one region of peak steady state stress 140 along the periphery of at least one of the first end 136 and the second end 138 of the pin 132. In one embodiment, the region of peak or maximum steady state stress 140 is identified by at least one of manual calculations, computer executed calculations and/or by computer executed algorithms capable of performing finite element analysis of a turbine blade.

At step 204, the method 200 includes defining a radially oriented fillet 154 along the corresponding periphery proximate to the region or regions of peak steady state stress 140. The radially oriented fillet 154 includes a point 158 along the corresponding periphery that defines a maximum radius of curvature value. The radially oriented fillet may be defined by a simple curve or by a compound curve.

At step 206, the method 200 includes identifying at least one region of peak vibratory stress 146 along the periphery of at least one of the first end 136 and the second end 138 of the pin 132. In one embodiment, the region of peak or maximum vibratory stress 146 is identified by at least one of manual calculations, computer executed calculations and/or by computer executed algorithms capable of performing finite element analysis of a turbine blade.

At step 208, the method further includes defining an axially oriented fillet 160 along the corresponding periphery proximate to a corresponding region of peak vibratory stress 146. The axially oriented fillet 160 includes a point 164 that defines a maximum radius of curvature value. The maximum radius of curvature value for the axially oriented fillet 160 being greater than the maximum radius of curvature value for the radially oriented fillet 154.

In one embodiment, the method 200 may further include defining a pair of the radially oriented fillets 154 disposed proximate to opposing regions of peak steady state stress 140 at one of the first or second ends 136, 138. In one embodiment, the method may include defining a pair of the axially oriented fillets 160 disposed proximate to opposing regions of peak vibratory stress 146 at one of the first or second ends 136, 138. In another embodiment, the method 200 comprises shaping the pin 132 along at least one of the first and second ends 136, 138 to have a cross sectional radial width 166 and a cross sectional axial width 168 where the cross sectional radial width 166 is less than the cross sectional axial width 168.

The various embodiments described herein and illustrated in FIGS. 8-14 provide one or more technical advantages over conventional turbine blades and methods for enhancing turbine blade life. For example, the pins of a pin bank or array are often the life limiting location for either low cycle fatigue or high cycle fatigue or both. Conventional pin designs for pin bank arrays provide uniform stiffness for both static (steady state) conditions and vibratory conditions which may not be optimal for either. By exploiting the understanding of the misalignment between the regions of peak steady state stress and the regions of peak vibratory stress, a more optimal pin design is achieved. Therefore, by optimizing the turbine blade design at the first and second ends of the pin, turbine blade life may be improved, thus allowing the part to safely run for an extended time interval by avoiding or delaying fatigue failure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A turbine blade, comprising:
a leading edge, a trailing edge, a pressure side wall and a suction side wall that extend between the leading and trailing edges, and a cooling passage defined between the pressure and suction side walls;
a pin disposed within the cooling passage, wherein the pin includes a first end connected to the pressure side wall and a second end connected to the suction side wall;
a radially oriented fillet disposed along a periphery of at least one of the first end or the second end within a region of peak steady state stress, wherein the radially oriented fillet has a maximum radius of curvature; and
an axially oriented fillet disposed along a periphery of at least one of the first end or second end within a region of peak vibratory stress, wherein the axially oriented fillet has a maximum radius of curvature value that is greater than the maximum radius of curvature value of the radially oriented fillet.

2. The turbine blade as in claim 1, wherein the radially oriented fillet extends towards a tip portion of the turbine blade.

3. The turbine blade as in claim 1, wherein the radially oriented fillet extends towards a root portion of the turbine blade.

4. The turbine blade as in claim 1, wherein the axially oriented fillet extends towards the leading edge of the turbine blade.

5. The turbine blade as in claim 1, wherein the axially oriented fillet extends towards the trailing edge of the turbine blade.

6. The turbine blade as in claim 1, wherein the turbine blade comprises a pair of the radially oriented fillets disposed along the periphery of the first or second end, each radially oriented fillet being proximate to an opposing region of peak steady state stress.

7. The turbine blade as in claim 1, wherein the turbine blade comprises a pair of the axially oriented fillets disposed along the periphery of the first or second end, each axially oriented fillet being proximate to an opposing region of peak vibratory stress.

8. The turbine blade as in claim 1, wherein the pin has a cross sectional radial width and a cross sectional axial width defined at each of the first end and the second end, wherein the cross sectional radial width of at least one of the first end and the second end is less than the cross sectional axial width.

9. A gas turbine comprising:
a compressor;
a combustor downstream from the compressor; and
a turbine having a plurality of rotatable turbine blades, wherein the at least one of the turbine blades comprises:
an airfoil having a leading edge, a trailing edge, a pressure side wall and a suction side wall that extend radially between a root portion and a tip portion and between the leading and trailing edges, and a cooling passage defined between the pressure and suction side walls proximate to the trialing edge;
a pin disposed within the cooling passage, wherein the pin includes a first end connected to the pressure side wall and a second end connected to the suction side wall;
a radially oriented fillet disposed along a periphery of at least one of the first end or the second end within a region of peak steady state stress, wherein the radially oriented fillet has a maximum radius of curvature; and
an axially oriented fillet disposed along a periphery of at least one of the first end or second end within a region of peak vibratory stress, wherein the axially oriented fillet has a maximum radius of curvature value that is greater than the maximum radius of curvature value of the radially oriented fillet.

10. The gas turbine as in claim 9, wherein the radially oriented fillet extends towards a tip portion of the turbine blade.

11. The gas turbine as in claim 9, wherein the radially oriented fillet extends towards a root portion of the turbine blade.

12. The gas turbine as in claim 9, wherein the axially oriented fillet extends towards the leading edge of the turbine blade.

13. The gas turbine as in claim 9, wherein the axially oriented fillet extends towards the trailing edge of the turbine blade.

14. The gas turbine as in claim 9, wherein the turbine blade comprises a pair of the radially oriented fillets disposed along the periphery of the first or second end, each radially oriented fillet being proximate to an opposing region of peak steady state stress.

15. The gas turbine as in claim 9, wherein the turbine blade comprises a pair of the axially oriented fillets disposed along the periphery of the first or second end, each axially oriented fillet being proximate to an opposing region of peak vibratory stress.

16. The gas turbine as in claim 9, wherein the pin has a cross sectional radial width and a cross sectional axial width defined at each of the first end and the second end, wherein the cross sectional radial width of at least one of the first end and the second end is less than the cross sectional axial width.

17. A method for enhancing mechanical durability of a turbine blade having a pressure side wall, a suction side wall, a cooling passage defined therebetween and at least one pin disposed within the cooling passage, the pin having an end connected to the pressure side wall and an opposing end connected to the suction side wall, the method comprising:
identifying at least one region of peak steady state stress along the periphery of at least one of the first end and the second end of the pin;
defining a radially oriented fillet along the corresponding periphery proximate to the region of peak steady state stress, the radially oriented fillet having a point along the corresponding periphery that defines a maximum radius of curvature value;
identifying at least one region of peak vibratory stress along the periphery of at least one of the first end and the second end of the pin; and
defining an axially oriented fillet along the corresponding periphery proximate to the region of peak vibratory stress, the axially oriented fillet having a point that defines a maximum radius of curvature value, wherein the maximum radius of curvature value for the axially oriented fillet is greater than the maximum radius of curvature value for the radially oriented fillet.

18. The method as in claim 17, wherein the step of defining a radially oriented fillet comprises defining a pair of radially oriented fillets disposed proximate to opposing regions of peak steady state stress at one of the first or second ends.

19. The method as in claim 17, wherein the step of defining an axially oriented fillet comprises defining a pair of axially oriented fillets disposed proximate to opposing regions of peak vibratory stress at one of the first or second ends.

20. The method as in claim 17, further comprising shaping the pin along at least one of the first and second ends to have a cross sectional radial width and a cross sectional axial width, wherein the cross sectional radial width is less than the cross sectional axial width.
